(19) United States
(12) Patent Application Publication
(10) Pub. No.: US 2011/0163231 A1
(43) Pub. Date: Jul. 7, 2011

(54) SECURITY PORTAL

(76) Inventor: Neil A. Salmon, Manchester (GB)

(21) Appl. No.: 12/998,103

(22) PCT Filed: Sep. 16, 2009
(86) PCT No.: PCT/GB2009/002210

§ 371 Date: Mar. 17, 2011

(30) Foreign Application Priority Data
Sep. 17, 2008 (GB) 0816978.1

(51) Int. Cl. G01T 1/00

(52) U.S. Cl. 250/336.1

(57) ABSTRACT

A security portal comprises an array of antenna elements and associated receivers sensitive in a frequency band chosen from within the centimetric to sub-millimetre wavelengths, the antenna array being located on a moveable panel. Radiation with the frequency band from a target person or object is measured at a first and second time within the near field of the antenna array, with the panel at corresponding first and second positions, the movement of the panel therefore allowing a more complete view of the target. The data received may be processed to form image data of the target. The moveable panel may comprise a part of a hinged, sliding or rotating door, or may be concealed behind stationary coverings that are transparent at the frequency band of interest.

This invention relates to security portals. In particular, it relates to portals that incorporate a radiation measurement function, the radiation being in the centimetric, millimetric, or low terahertz frequencies. It further relates to portals that produce images based upon the measurements made, and also portals that merely provide an indication based upon measurements made, without production of an image.

Security portals are increasingly commonplace in airports, and in entrances to buildings such as government offices etc. Their use is growing because of increased security fears and terrorist threats. Following high profile and well publicised attacks, defences against threats such as suicide bombs, as well as more traditional threats such as from guns and knives are sought.

Most portals commonly in use today comprise a doorway or arch that incorporates a metal detector able to detect and approximate a location of metallic objects about a person passing through. These are useful in the detection of traditional guns and knives, so long as security personnel are on hand to frisk anyone setting off an alarm on the detector. They are less useful against modern non-metallic threats, such as plastic explosives and ceramic knives.

Imagers and other detectors operative in the millimetre waveband or thereabouts are starting to enter the field. These are frequently able to spot these modern threats, as well as the more traditional ones. Applicant's co-pending U.S. patent application Ser. No. 11/665,540 discloses an imager that uses radiation naturally generated by the human body, and is able to spot threats though clothing. Applicant's U.S. Pat. No. 7,271,899 discloses a system operable in the millimetre waveband or thereabouts which can do the same without generating image data, which eases peoples privacy fears somewhat, increases personnel throughput and also makes for a much simpler and cheaper installation. These devices rely on temperature differences and/or material reflectivities and other material properties when seen at their particular operating wavelengths to provide contrast between the objects of interest and the background human body.

WO2005/050160 discloses a portal for the detection of concealed objects about the person. This uses an array of transceivers that are adapted to move around the person, transmitting and receiving electromagnetic radiation, and using information gained therefrom to form an image. Active systems such as these are expensive, and may be subject to real or perceived safety concerns.

Applicant's co-pending application, publication No. WO 2007/054685, the contents of which are incorporated herein by reference discloses a portal operative at millimetre wavelengths, or thereabouts, wherein an array of antenna elements are arranged on the walls of an enclosure and are used to receive the radiation picked up from a person under observation. Array processing techniques are used on the signals received, giving benefits in terms of beam steerability and depth of field. Populating every wall with sufficient receive elements to provide a full image of all sides of the person under observation is currently prohibitively expensive, due to the cost of the individual receive elements, and also the cost of the computer processing power needed to process the received signals.

According to the present invention there is provided a security portal comprising an opening for the passage of a target person or object and a moveable panel, the panel comprising an array of antenna elements arranged to provide signals to an array of receivers, the antenna elements being sensitive to radiation within a band within a range between centimetric wavelengths and sub millimetre wavelengths, the panel being adapted to be moveable from a first to at least a second position,
characterised in that the antenna elements and receivers are arranged to provide a near-field focus region, wherein the portal is arranged to take a first measurement of the target when the panel is in a first position and to take at least one further measurement when the panel is in a second position, the first and further measurements each creating image data of a part of the target in the focus region, and wherein the portal does not provide a coherent illumination source for illuminating the target.

Preferably the portal is entirely passive, in that it does not purposely generate any energy for transmission and illumination of the target.

The panel may conveniently be a door. The door may be of any suitable type. For example, the door may be a sliding door, or a more traditional hinged door. Alternatively, the door may be a rotating door.

The panel may act so as to provide a block on passage through the portal when in a closed position. A target user will then only gain passage when the panel is moved to an open position. This may be used to control the pace of the target though the portal to help ensure a proper measurement is made.

The panel may act so that it does not present a block to passage through the portal, It may for example comprise a moveable panel that forms part of a wall of the portal, or which extends out from the wall.

The antenna elements on the panel may be arranged as a set of sub-arrays. Each sub array may comprise a sub set of the antenna elements on the panel. A sub-array may advantageously comprise a horizontal row of antenna elements. The row of elements forming the sub-array may comprise all antenna elements in that row, creating a single sub-array per row. Alternatively, the row of antenna elements may be divided up into a plurality of sub-arrays. The array or each antenna sub-array may advantageously be arranged to provide a near-field focusing action in one dimension, such as a horizontal dimension, this focusing being achieved in any suitable manner. A sub-array is preferably focused at a distance at which a target will typically be during the imaging process. The focusing may be achieved by, for example, combining outputs from a sub-array of antenna elements, in a combiner, with the elements being connected to a combiner using suitably selected transmission line lengths. The combiner thus acts in this instance as a fixed beamformer. The implementation of a focusing means for focusing an array of antennas in the near field in this manner, would be understood by a person normally skilled in the art. The array may also be focused in the near field using a time-delay or phase shift beamformer, e.g. a Butler matrix or a Rotman lens.

In a dimension orthogonal to that in which the sub-arrays are arranged to be focused, the antenna element beam pattern is advantageously arranged to be wide. The half power beamwidth in this dimension may advantageously be around 40°, 50°, or 60°, or thereabouts. This will typically be the vertical axis dimension. The panel may comprise a vertical stack of sub-arrays, the outputs of which may be processed in a beamformer. The stack of sub arrays may for some applications be arranged such that it forms a sparse array in the vertical axis. The degree of sparsity may be a compromise between system cost and required system sensitivity. Systems required to have better sensitivity will typically have a smaller spacing between sub-arrays (i.e. a reduced sparsity), which of course means that more sub-arrays, or more antennas per sub-array are required for a panel of a given size.

The spacing of sub-arrays in the vertical dimension need not be constant throughout the panel. For example, an increased density may be used for those sub-arrays that are more likely to view the torso of a person as compared to those viewing the legs.

The antennas making up the array may be of any suitable type. Advantageously, patch antennas may be used, these having an advantage of being planar, the planarity making for straightforward integration with the panel itself. Typically the thickness of a patch antenna will be of the order 0.15λ. Other suitable antenna types include slot antennas, and horn antennas, but these usually have physical sizes greater than the patch antenna.

Beamformed signals from a group of sub-arrays of antenna elements may be combined in a second beamformer. The second beamformer may be adapted to provide image information relating to a vertical aspect of the scene. The second beamformer is preferably a digital beamformer. The digital beamformer may use a correlation imaging algorithm as detailed in co-pending patent application WO 2007/054685, pages 15-20. This is an algorithm adapted from astronomical applications to focus in the near field of the antenna array.

The system may be arranged to have a centre frequency, and bandwidth to suit the conditions and desired system parameters. For example, a higher centre frequency will generally provide better image resolution, but countering this is the generally increased opacity of clothing and other materials with frequency.

The first and second measurements are preferably timed so as to allow radiation from different parts of the target to be measured. Thus, as the panel moves in relation to the target, a more complete image of the target may be generated. Additional measurements, such as third, fourth, fifth etc measurement may be made as the panel moves to provide further image information.

The movements and speed of movement of the panel may advantageously be controlled depending upon the exact speed and location of the target. This may be determined using known techniques, such as by imaging the target with a video camera from a known location and processing the resulting set of images to produce the location and speed information. This information then allows the panel to track the target to increase the useful sampling over the target or subject, thereby increasing the signal to noise ratio and hence also the useful information content. Furthermore, embodiments of the invention may be arranged to take measurements focusing at different distances and positions, and may do this relatively quickly compared to the movement speed of the target. The resulting data, which may also include data from movement of the panel, may be combined as desired to provide alternative or enlarged viewpoints of the target.

The resultant image can be imaged processed using image processing algorithms similar to those already used in e.g. x-ray security devices to identify anomalies which may lead to intervention by security personnel. Raw image data may also be presented to security personnel, although privacy issues may make this unacceptable in some environments or applications.

The present invention will now be described in more detail, by way of example only, with reference to the following Figures, of which:

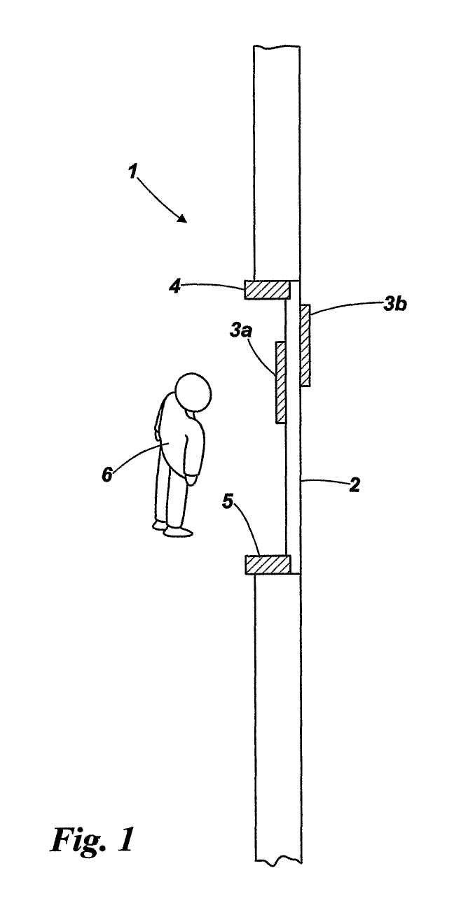

FIG. 1 diagrammatically illustrates a first embodiment of the present invention, wherein a security portal is integrated into a sliding door;

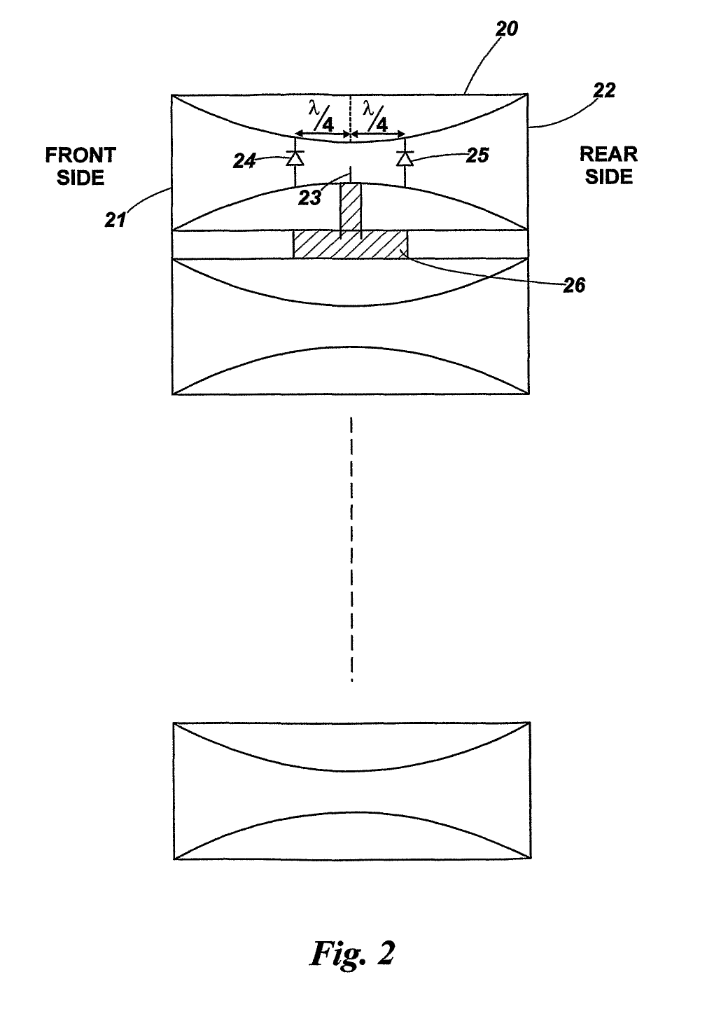

FIG. 2 diagrammatically illustrates an arrangement wherein more than one antenna element may be used with a single receiver or combiner input, the antenna elements being switchable;

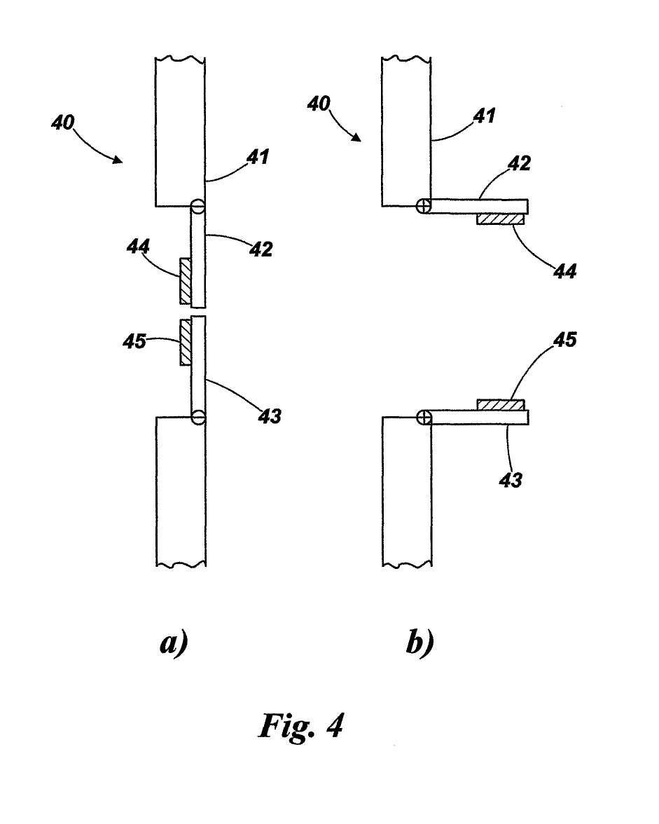

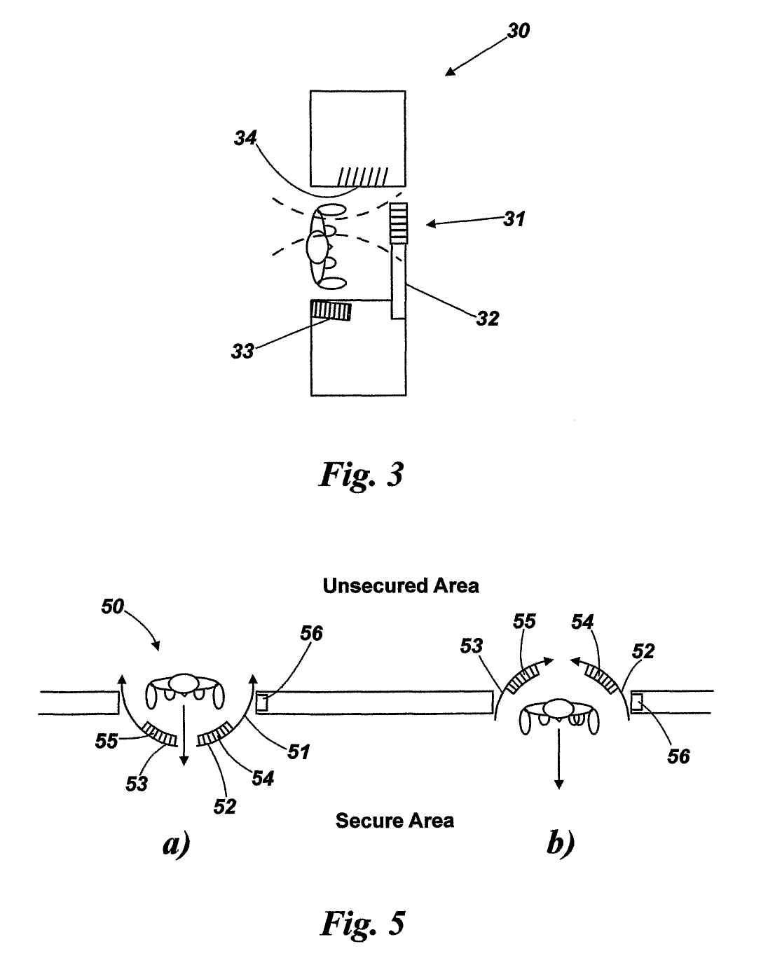

FIG. 3 diagrammatically illustrates a second embodiment of the present invention, wherein a security portal is integrated into a sliding door, and wherein a mirror arrangement allows a greater part of a target to be imaged;

FIG. 4 diagrammatically illustrates a third embodiment of the present invention wherein a security portal comprises double hinged doors;

FIG. 5 diagrammatically illustrates a fourth embodiment of the present invention wherein a security portal comprises a turnstile type door;

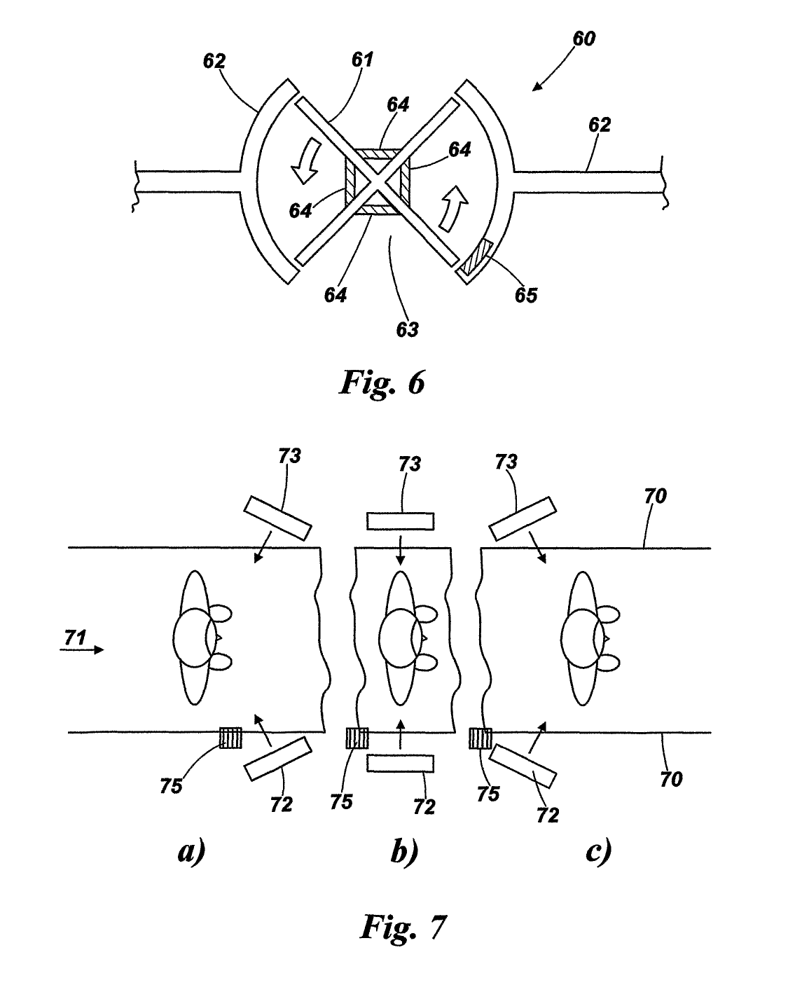

FIG. 6 diagrammatically illustrates a fifth embodiment of the present invention wherein a security portal comprises a rotating door;

FIG. 7 diagrammatically illustrates a sixth embodiment of the present invention wherein a security portal is integrated into a corridor;

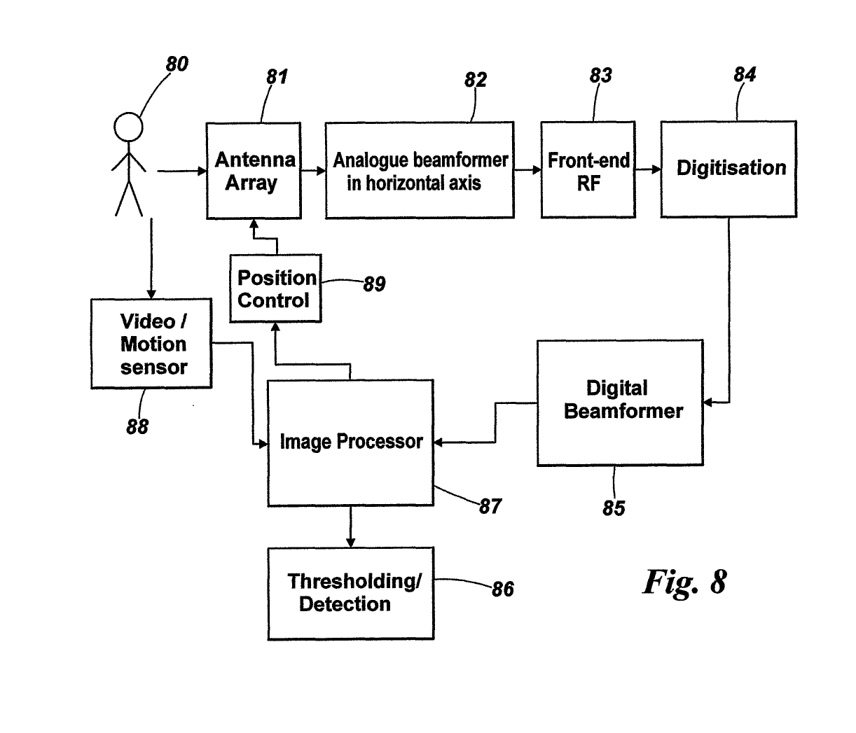

FIG. 8 shows a high level system block diagram of an embodiment of the invention;

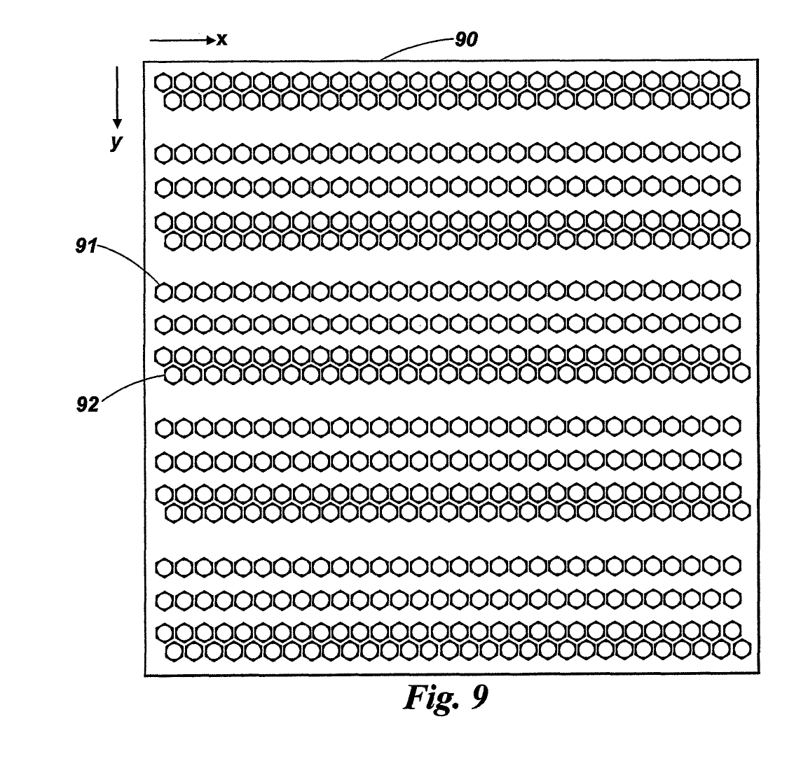

FIG. 9 diagrammatically illustrates a typical layout of antennas on a panel as may be employed in embodiments of the present invention.

FIG. 1 shows a first embodiment of the present invention. Shown in plan view, a dividing wall 1 contains a sliding door 2, here shown in the closed position. Integrated within the sliding door 2 are panels 3a, 3b having mounted thereupon an array of antennas (not shown). The panels 3a and 3b are each placed on opposite sides of the door 2. The antennas are connected to a receiver bank containing down conversion and digitisation means. Positioned on each side of the doorway are panels 4 and 5 that also each comprise an array of antenna elements connected to the receiver bank. The antennas and receivers are sensitive to radiation in a band centred on 35 GHz and having a bandwidth of approximately 1 GHz. The digitisation means has a very high speed optical output and is connected via a fibre optic link to a remote signal processing and display facility (not shown).

Each panel 3a, 3b comprises a hexagonal array of antenna elements, arranged as 80 rows, by 40 columns. The antenna elements are spaced at intervals of 0.75λ between columns (i.e. the horizontal spacing), whereas the spacing between rows (i.e. the vertical spacing) is greater, making the array a sparse one in the vertical axis, it being 50% filled. Each row of antenna elements is combined in a passive combiner to form sub-arrays using connector lengths chosen to focus the receive beam of the sub-array at a distance of nominally 40 cm therefrom, although because of the Gaussian nature of the beam it will still be focused to some degree for some way either side of this. This provides an in-focus region having a horizontal width parallel to the panel of approximately 1 cm. Of course, the system could be supplied with a more complex arrangement of combiners that were adapted to provide a plurality of focusing distances from the array.

A typical panel may be approximately 40 cm wide to give the approximate 1 cm focal region at 30 GHz. The height of the panel is typically around 1.5 m, but may be chosen according to the application and the target view required.

Note that for all embodiments described herein, the outputs from the plurality of sub-arrays may be processed so as to provide depth information, enabling the system to generate voxels, i.e. 3D image information including the depth plane. Information from a plurality of sub-arrays will be used in calculating image data relating to each voxel. The voxel information gathered may be converted to 2D information by collapsing the voxel information along any axis, and hence may be used to provide differing views of a target.

A target 6 (a person in this case) approaching the door will naturally emit radiation at the frequency of interest. This will be intercepted by the antennas initially primarily in the front side 3a of sliding door panel. Thus image information from the front of the person 6 is received, and may be processed as necessary to form an image.

As the person gets closer to the door he will come into the field of view of the side panels 4, 5, enabling them to receive radiometric emissions primarily from the sides of the target. This energy is processed in a similar way to that received by the front panel 3a, and so a more complete image of the person is formed in the signal processing and display facility.

A conventional movement detector (not shown) attached to the doorway detects the presence of the person and commands the door 2 to open. The person 6 may then pass through the doorway. Whilst doing so the side panels, along with their associated antennas, receivers and signal processing, will continue to image the person, to build upon the image information already gained. The door panel 3a will likewise continue to receive and process information also. The movement of the door 2 means that panel 3a will see a different perspective of the person, and so will be able to generate further useful image information of the person.

The side panels 4, 5, may advantageously be mounted at an angle to the doorway such that they are better able to image the back of the person as he passes through the doorway, whilst still being able to see the sides of the person. The angle will typically be around 15°-25°, although other angles may be used.

To improve sampling in other regions panels may also be located above the target to detect threats concealed on the top of the shoulders and head, within a hat, wig, veil, turban, Burqa, long hair, beard or moustache and a panel may also be located on the floor to detect threats concealed around the feet and ankles. These panels may also be moveable.

When the person has passed through the doorway he will enter the field of view of the panel 3b on the opposite side of the door 2. This will receive energy from the back of the person as he walks away. Therefore image information from substantially the whole of the circumference of the target may be produced.

Whilst the panels 3a and 3b may each be connected to their own receiver arrays, this is a relatively expensive option. An alternative to this which avoids the expense of a complete second receiver array is shown in FIG. 2.

A dual horn antenna 20 has receive apertures 21 and 22 on opposing sides. Positioned on the centre of the antenna 20 is an RF to microwave transition 23 as is commonly employed in horn antennas. Mounted either side of the transition 23 are P-I-N diodes 24, 25. These are each located a distance of λ/4 axially from the transition 23, where λ is the wavelength in the centre of the waveband being measured by the system.

The transition 23 is connected to receiver 26, where received signals are down converted and digitised, and sent to the signal processor. In use one of the diodes 24, 25 is forward biased so that it acts as a short, whilst the other is reverse biased. If it is desired to receive signals from the front side through antenna aperture 21 then diode 25 is forward biased. This has the effect of preventing signals from the rear side from reaching the transition 23 whilst allowing signals from the front side. Similarly, should it be desired to receive signals from the rear side, then diode 25 is reverse biased and diode 24 forward biased. In this manner a single receiver 26 may be used to receive radiation selectively from either the front side or the rear side as desired.

The antenna outputs may alternatively go to an input of a combiner, along with inputs from other antennas in a sub-array, and the signals combined together before going to a receiver.

A dual-patch antenna may be used instead of the dual-horn antenna in the embodiment described above. Again, a PIN diode switch may be used to select one of the pair of antennas, with for example a PIN diode being located in a waveguide transmission line connected to each antenna.

Panels 3a and 3b as shown in FIG. 1 may be replaced with a single, double sided panel, that comprises an array of the antennas as described in relation to FIG. 2. Appropriate biasing of the selection diodes enable the system to select the direction from which it is to receive the radiation.

A movement detector (not shown) may be used to monitor the progress of the target though the doorway, and to provide a switching signal to the antenna diodes when the target may best be imaged by switching antennas.

FIG. 3 shows in plan view a second embodiment of the present invention, this being variant of the embodiment described in relation to FIG. 1, again designed to reduce costs. Portal 30 has a doorway 31 and a sliding door 32. The sliding door and its associated receiver panel(s) work in the same way as described in relation to the above embodiments, and will not be described further. Located on one side of the portal doorway 31 is a panel 33. This comprises an array of antennas and, like the side panels 4 or 5 described above, collects radiation from a region in front of it. On the other side of the doorway 31 is a mirror 34, made from a metal sheet, although any suitably reflective material could be used, such as Pilkington K-glass.

As the target approaches the doorway 31, radiation emitted therefrom will be detected by the side panel 33 so enabling a nearest side of the target to be imaged. As the target moves through the doorway radiation emitted from the far side of the target from the panel 33 will be reflected from the mirror 34 towards the panel 33. This enables the far side of the target to be imaged also.

The signal processing attached to the receivers is a correlation signal processing technique as described in co pending patent application WO 2007/05468 as mentioned above, and is therefore able to post process the received information so as to focus on any appropriate distance and direction. Thus by appropriate focusing the signal processing is able to distinguish the radiation received from the near side of the target from that received from the far side.

The front and back of the target will of course also be imaged by radiation received by the panel(s) in the sliding door as described above.

To facilitate the measurement of both the near and the far side of the target, the positions of the panel 33 and the mirror 34 are preferably chosen to optimise a beam pattern on the target. This may involve angling or shaping the panel 33 and/or the mirror 34. For example the mirror may have a concave profile to compensate for the additional path length taken by the reflected radiation, so that the reflected radiation appears to emanate from a region within the focal range of the system.

The exact form of the curvature of the mirror will depend upon the properties of the receive antenna beam, both in the individual sub-arrays and in the second beamformer, and also the relative locations of the panel, the mirror, and the target. In practice it could be concave, convex, or a complex combination of both.

FIG. 4 shows in plan view a third embodiment of the present invention. FIG. 4a shows portal 40 comprising a doorway 41 with a pair of swing doors 42, 43, in a closed position. Located on each door is a panel 44, 45 comprising an array of antenna elements along with their associated receivers. As in the previous embodiments, each panel is connected by a high speed data link to a signal processing and display facility.

Each panel 44, 45 is adapted to receive information in the waveband of interest from a region in front of it. Thus, with the doors 42 and 43 in a closed position, the panels will each receive information from a field of view on the left of the portal as it appears in the Figure. A target approaching the doors 42, 43 from the left will therefore be imaged from the front by the panels 44, 45. A movement sensor (not shown) is adapted to provide a signal to the doors telling them to open when the target is close to the doors. FIG. 4b shows the doors in an open position. Here, the panels are now facing in from the side. As the target moves through the doorway the panels will receive radiation from the sides of the target, thus allowing imaging from those regions of the target.

The panels are adapted to receive radiation continuously as the target moves through and out of the doorway. The information measured during this time may be processed to focus on different regions, and so some, albeit a more limited amount of radiation from the back of the target will be detected by the panels, allowing a limited view of the back of the target to be imaged. When the target has passed through the doorway the movement detector causes the doors to close ready for the next target to pass through.

FIG. 5 shows in plan view a fourth embodiment of the present invention. FIG. 5a shows a portal 50 comprising a turnstile type doorway 51. The turnstile 51 comprises a pair of moveable barriers 52, 53, adapted to be able to move from a first position to a second position. The barriers are, in FIG. 5a, shown in the first position. Positioned on the barriers 52, 53 are a pair of panels 54, 55 containing an array of antennas and receivers as described above in relation to the first and second embodiments. Again, a signal processing and display facility is connected thereto by a high speed bus, and is located remotely from the doorway itself. Of course, it may be located in any convenient location in practice, such as adjacent the doorway. A movement detector 56 is adapted to electrically command the barriers to move between the first and second positions on request.

When in the first position a target, such as a person, may move to a marked region adjacent the barriers. The person is then within range of the panels, and so the antennas and receivers located thereupon will receive radiometric emissions in the band of interest emitted or reflected largely by the front and sides of the person. This may be processed as in the other embodiments to produce image information of that part of the person.

The movement detector, upon detecting a target in the marked region, now commands the barriers to move from the first position to the second position.

This is shown in FIG. 5b. During the movement, the panels 54, 55, will continue to receive and process radiation from the target, which is used to provide additional image information in the signal processing facility.

When the barriers reach the second position, the person is free to walk away. The panels are now located at the back of the person and so may, at this time, receive radiation therefrom, and transmit this information to the signal processing facility. Thus due to the movement of the barriers 52, 53, image information has now been gathered from all sides of the target, allowing a substantially complete image to be produced.

When the person has moved off from the marked region, as detected by the movement detector 56, the barriers 52, 53, are moved back to the first position ready for the next one.

Additionally, whilst the barriers are in both their first and second positions ingress through the doorway is prevented, providing greater security.

FIG. 6 shows in plan view a fifth embodiment of the present invention. A security portal 60 comprises a central rotatable door 61 in a fixed wall 62. The rotatable door 61 forms with the fixed wall a set of compartments in conventional manner, with a person entering a compartment e.g. 63 at one side of the wall being passed through to the other side by means of rotation of the door. Located within each compartment e.g. 63 on the door, on two sides of the compartment, is a panel 64, positioned to face the front of a person as they enter the compartment. Each panel 64 comprises an array of antenna elements arranged as a set of sub-arrays as previously described. The sub-arrays are adapted to focus at a distance at which a typical user stands from the panel when using this type of door. As the door 61 rotates, the panel 64 rotates with it. A fixed panel 65 located in the wall 62 images the person from a different viewpoint.

Each panel contains digitisation means for digitising the signal received by the antennas and processed by receivers. The resulting digital signals are sent to a signal processor for processing into image data.

A person entering a compartment formed by the door and wall will have the front of their body facing the rotatable panel 64, whilst the fixed panel 65 will be facing their right side. Both panels will be able to take image data of these areas at this time, As the person progresses through the doorway the door will rotate and hence the panels will move in relation to the person. Image data will continue to be gathered during this time. Image data from a single panel will comprise a succession of narrow vertical strips, each a complete image of that part of the target at the focal distance of the array, and as each measurement is done the image data from a plurality of vertical strips may be accumulated using the signal processing means and displayed as necessary on a conventional display. As the raw data comprises voxel data that can be processed as previously described, it can be used to provide viewpoints of the target as seen from different positions.

The panels 64, 65 may be arranged to move in relation to the door as the door rotates, for example using a hinged mechanism, to assume positions that increase the likelihood of taking measurements from a larger region of the target.

FIG. 7 shows in plan view a sixth embodiment of the present invention. A security portal comprises a pair of parallel walls 70 arranged to define a corridor or walkway 71, through which people (or other targets) may pass. The walls 70 are transparent to radiation at millimetre wavelengths or thereabouts, but are opaque to visible radiation. A pair of panels 72, 73 are located behind the walls, one on each side, each panel comprising an array of antenna elements and receivers as described in relation to FIG. 1 above. The panels 72, 73 have a data connection to a signal processor and display apparatus. Each panel 72, 73 is also moveable, and is connected to a position controller (not shown) adapted to swivel the panel about a vertical axis as required. A movement detector/locator 75 detects an oncoming person, and feeds this into the position controller. The position controller ensures that the panels are moved to a start position allowing them to take measurements from the front of the person.

FIG. 7 shows three views of the embodiment, each with a person being viewed at different points in the portal. FIG. 7a shows a person approaching the panels. In this position the panels are rotated so as to be able to receive radiation from the front of the person.

As the person moves down the corridor, the movement detector/locator 75 provides updated position data on the person to the position controller. The position controller uses this information to keep the panels pointing at the person as they move past. Thus at FIG. 7b, the person is directly between the panels 72, 73, and the panels have rotated to maintain their active faces pointing at the person, so imaging the sides of the person. Similarly, at FIG. 7c, the person has passed beyond the panels, which have rotated to keep their active faces pointing now at the back of the person. During this passage, the panels are taking measurements of the person as described above, and are transmitting the measurement information to the signal processor. There the information is accumulated and processed to provide image data of the person, which may then be displayed to an operator. As the panels track the movement of the person the image information they obtain will be from different parts of the target, so that image information from a large part of the circumference of the target may be obtained. Once the target has passed by the panels the movement detector/locator will provide a signal to the panels' movement controllers to move the panels back to the start position ready for the next target.

FIG. 8 shows a high level block diagram of an embodiment of the invention. A person 80 radiating energy in the millimetre wave band (amongst others) provides the input to an antenna array panel 81. This comprises an array of patch antennas, the array being a 2D array sparse in the vertical dimension. Each element in a given row of antennas is combined together in a fixed analogue beamformer 82, with signal line lengths connected to each antenna being used to define a beam in the horizontal plane.

Each beamformer at step 82 provides an input to an RF amplifier and filter at 83. This may also include a down conversion stage if the input frequency of interest is particularly high. The output of this stage is digitised at step 84 with a fast, short word digitiser. A 1 bit digitiser is used, although other bit lengths, such as 2 or 4 may also be used.

The digitised information is then input to a beamformer 85. This combines the inputs together to generate beams focused at varying distances from the array. Thus typically many image planes are produced, allowing images to be produced and displayed to an operator that have a large depth of field. The digital beamformer 85 may use known algorithms such as the near field correlation imaging algorithm described in co-pending application WO2007/054685, included herein by reference.

A video camera, or motion sensor 88, located where it can get a good view of person 80 approaching the portal containing the antenna array panel 81 described above, provides information to image processor 87. Processor 87 is able to use this information to move the antenna array panel 81 at an opportune moment so as to obtain millimetre wave measurement data from different directions relative to (and hence get a more comprehensive view of) the target person 80. The image processor provides an output to a position controller 89 mechanically connected to antenna panel 81 that is able to move it from a first to a second position. This may also be used to control e.g. a sliding door, an automatically rotating door, or a portal exit door.

The output from the digital beamformer 85 may be processed at image processing step 87 for display to an operator, and/or input to a thresholder or detector 86 (which may use e.g. a Constant False Alarm Rate (CFAR) algorithm) to alert an operator to any potential threats carried by the person 80.

FIG. 9 shows a typical layout of antennas on a panel, as may be employed in embodiments of the present invention. Panel 90 comprises a 2D array of patch antenna elements e.g. 91, this array being fully filled in the horizontal (x) axis, but sparse in the vertical (y) axis. The panel has 30 antenna elements in each row e.g. 92. Each row e.g. 92 may be arranged as a separate sub-array, wherein all antennas within the sub-array are fed to a combiner acting as a beamformer, and from there to a receiver. The antenna element size, and hence the panel size, is dependent upon the wavelength of the radiation being received. A typical antenna element spacing is as described in relation to FIG. 1 above, i.e. 0.75λ in the x axis, with y axis being spaced to achieve a 50% filling factor. A portal as described in the above embodiments may comprise any suitable number of such panels.

The embodiments above employ receiving and processing systems that are sensitive enough to detect small changes in the radiometric temperature of different parts of the target without requiring illumination means of either a coherent, narrowband nature (as is often employed in prior art systems). The number of receive elements, coupled with the integration times found when looking at targets such as people passing through a portal, mean that illumination systems are not required. If targets were employed that passed through the portal much faster, such as items on a fast conveyor, then a noise source illuminator may be employed. These do not generate coherent illumination.

In all embodiments disclosed the operator may, if he so wishes, hide the existence of the panels from the targets being imaged. For example, a covering opaque to visible light, but largely transparent to the radiation as detected by the antennas and connected receivers, may be applied to the panels and mirrors. Such a covering has the benefit of physically protecting the antennas from accidental damage as may be caused by being hit with baggage etc, as may occur in an airport environment. The invention makes it relatively straightforward to hide the panels as the passive nature of the receiving system means that no transmissions are made towards the target, and hence the target cannot itself use receiving equipment to detect its presence.

The above examples have been disclosed for illustrative purposes, and those skilled in the art will appreciate that various modifications, additions and substitutions are possible, without departing from the scope of the invention as disclosed in the accompanying claims.

1. A security portal comprising an opening for the passage of a target person or object and a moveable panel, the panel comprising an array of antenna elements arranged to provide signals to an array of receivers, the antenna elements being sensitive to radiation within a band within a range between centimetric wavelengths and sub millimetre wavelengths, the panel being adapted to be moveable from a first to at least a second position,
characterised in that the antenna elements and receivers are arranged to provide a near-field focus region, wherein the portal is arranged to take a first measurement of the target when the panel is in a first position and to take at least one further measurement when the panel is in a second position, the first and further measurements each creating image data of a part of the target in the focus region, and wherein the portal does not provide a coherent illumination source for illuminating the target.

2. A portal as claimed in claim 1 wherein the array of antenna elements are arranged as a plurality of sub-arrays, each sub-array comprising a plurality of antenna elements, and wherein each sub-array has an associated beamformer.

3. A portal as claimed in claim 2 wherein each beamformer is adapted to provide each sub-array with a focal point in the near field of the sub-array.

4. A portal as claimed in claim 3 wherein the sub-arrays are arranged such that the focal points of each together form a focal line in an axis parallel to the panel.

5. A portal as claimed in claim 1 wherein a processor is arranged to receive data from the first and further measurements and to combine it into a composite image of the target.

6. A portal as claimed in claim 1 wherein a movement detector and position locator is used to track a position of a target, and to provide signals to a panel position controller, the position controller adapted to move the panels in response to said signals.

7. A portal as claimed in claim 1 wherein the panel is located on a sliding door.

8. A portal as claimed in claim 1 wherein the panel is located on a rotatable door.

9. A portal as claimed in claim 1 wherein the panel is located on a hinged door.

10. A portal as claimed in claim 1 wherein the panel is located on a wall adjacent a walkway.

11. A portal as claimed in claim 10 wherein a mirror is located opposite the panel and arranged to reflect radiation from a target to the panel.

12. A portal as claimed in claim 2 wherein each sub-array has an associated analogue combiner adapted to combine inputs from each antenna element in the sub-array in a focused manner.

13. A portal as claimed in claim 12 wherein digitising means is incorporated that is adapted to digitise outputs from the combiners, and a beamformer is incorporated to process the digitised signals to produce a plurality of beamformed outputs.

14. A portal as claimed in claim 13 wherein the digital beamformer is adapted to use a near-field correlation algorithm.

15. A portal as claimed in claim 12 wherein the focusing means is adapted to focus at a plurality of distances from the array and to generate image information relating to the plurality of distances.
